(19) United States
(12) Patent Application Publication
(10) Pub. No.: US 2017/0326910 A1
(43) Pub. Date: Nov. 16, 2017

(54) WHEEL RETENTION SYSTEM

(71) Applicant: Michael Ferman, Peakhurst (AU)

(72) Inventors: Michael Ferman, Peakhurst (AU); Oliver Clemens Robert Kratzer, Ballina (AU)

(21) Appl. No.: 15/531,196

(22) PCT Filed: Nov. 27, 2015
(86) PCT No.: PCT/AU2015/000721

§ 371 Date: May 26, 2017

(30) Foreign Application Priority Data
Nov. 27, 2014 (AU) 2014904801

(51) Int. Cl. B60B 3/16; F16B 39/10

(52) U.S. Cl. CPC B60B 3/165; F16B 39/101; B60B 2310/305; B60B 2900/3312

(57) ABSTRACT

An anti loosening arrangement doer wheel nuts which uses wheel rim with a plurality of studs having external threads to receive fastening nuts, a wheel nut with an internal thread adapted to be secured to said studs a connector adapted to be attached to and connect adjacent nuts said connector including a mechanism to prevent rotation of the nuts. This arrangement does not require a custom stud. In some preferred mechanisms custom nuts may be needed but in other preferred embodiments conventional nuts may be used. The connector prevents rotation of the nuts and so inhibits loosening. The connector is easily seen and is an indication that the wheel nuts are unable to be loosened.

This invention relates to wheel nuts for retaining vehicle wheels on the wheel hub and for ameliorating the risk of the nuts becoming loose.

### BACKGROUND TO THE INVENTION

In order to prevent wheel nuts loosening one approach has been to provide a stud for the nut that has an internal thread of opposite hand to the thread of the nut. Such an arrangement is disclosed in U.S. Pat. No. 6,916,144.

Another proposal is to use a compression collar for the nut as in U.S. Pat. No. 6,935,825.

A more recent approach is disclosed in Au 2009905537 which uses a custom wheel stud having an external thread to co-operate with the internal thread of said wheel nut has an end portion adapted to project beyond the wheel nut and a retaining cap with internal grooves or ribs complementary to external ribs or grooves on said wheel stud adapted to fit over said wheel stud with and means to secure the retaining cap to said wheel nut.

In these arrangements it is important to have tamper proof nut assembly that visibly indicates that the nut is tightened. In addition it is usual to provide an aesthetic cap or cover for the nut.

It is an object of this invention to provide a tamper evident wheel retention arrangement that does not require a custom stud.

### BRIEF DESCRIPTION OF THE INVENTION

To this end the present invention provides a wheel nut assembly for fixing a wheel to a vehicle hub which includes

A wheel rim with a plurality of studs having external threads to receive fastening nuts:

a wheel nut with an internal thread adapted to be secured to said studs

a connector adapted to be attached to and connect adjacent nuts

said connector including a mechanism to inhibit rotation of the nuts.

This arrangement does not require a custom stud. In some preferred mechanisms custom nuts may be needed but in other preferred embodiments conventional nuts may be used. The connector prevents rotation of the nuts and so inhibits loosening.

The connector is easily seen and is an indication that the wheel nuts are unable to be loosened.

The connector may take a variety of forms and may be in more than one piece.

In one embodiment the connector has as many parts as there are studs and these engage each other to form a ring connector connecting all the studs on the wheel rim.

In another embodiment the connector is adjustable in length to accommodate a variety of distances between studs.

It is not essential for the system to prevent any loosening of the nuts. The system prevents the nuts becoming detached from the studs.

A locking mechanism with a key may be used to lock the connector in place. The connector may include a visual indicator that the connector is locked in place. This not only prevents the wheels becoming detached from the wheel hub but also prevents the theft of wheels which is a problem in some countries.

In another embodiment the connector may be secured to a custom wheel rim and is rotatable to align with the nuts and lock them in place.

### DETAILED DESCRIPTION OF THE INVENTION

Various preferred embodiments of the invention will be described with reference to the drawings in which the connector is shown on a wheel rim;

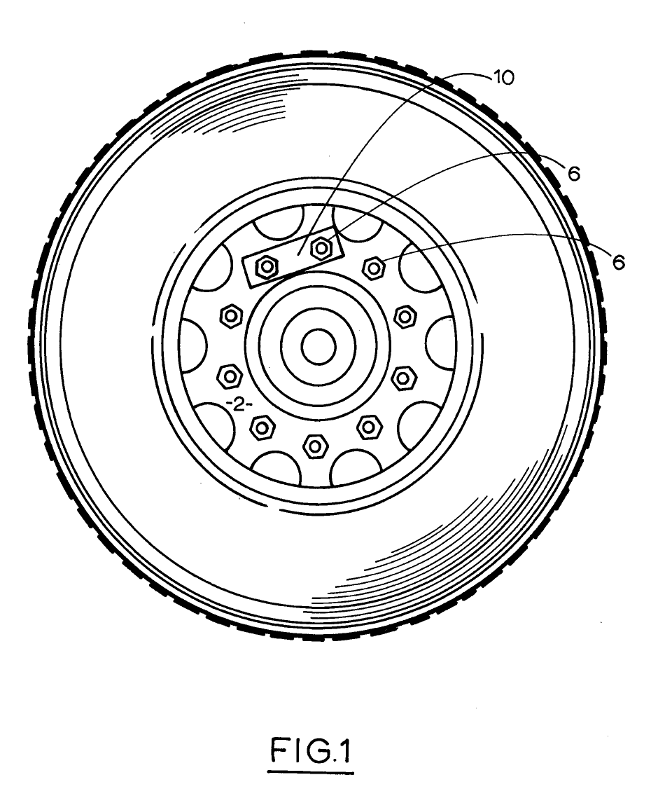

FIG. 1 illustrates a side view of the

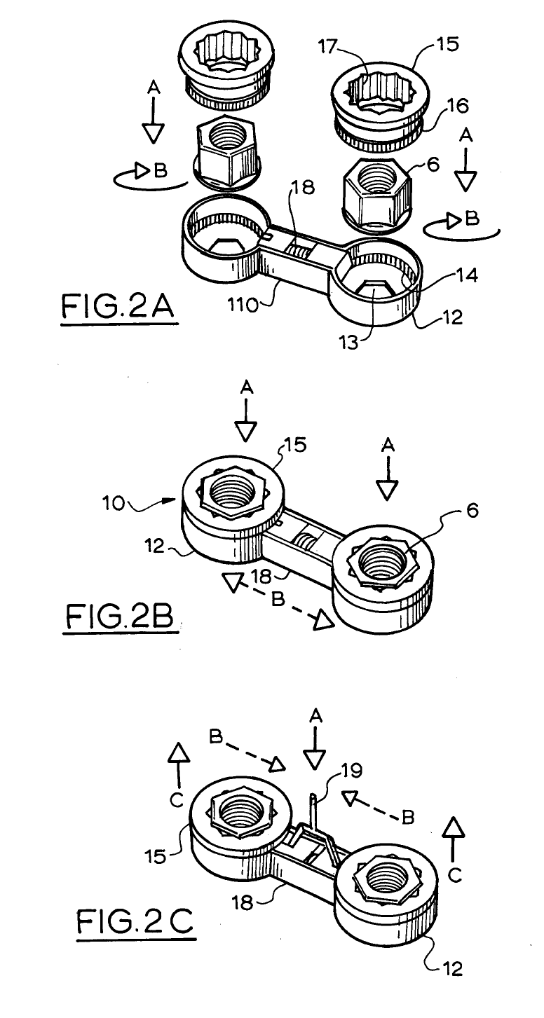

FIGS. 2A B and C illustrates an exploded view of the connector, a lock and unlock position respectively of a first embodiment of the connector;

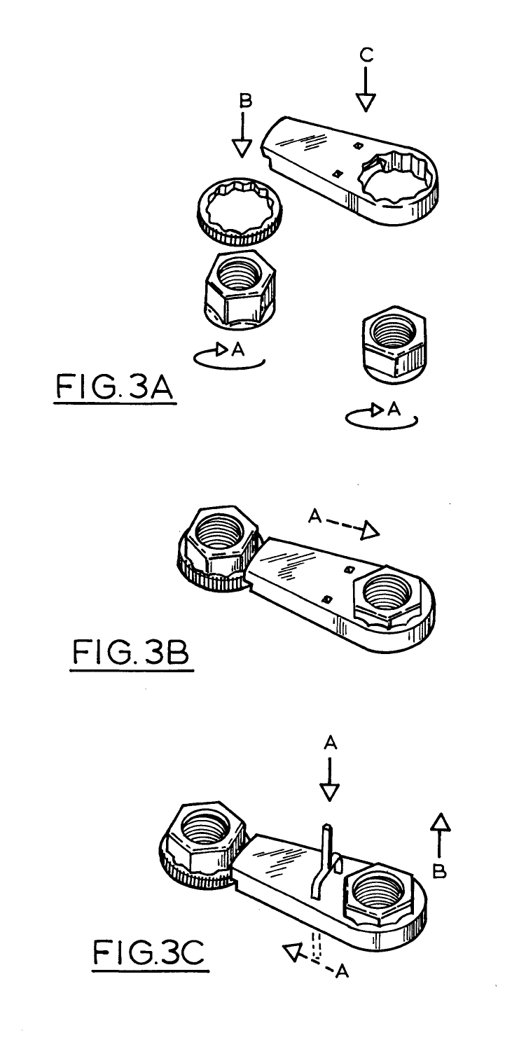

FIGS. 3A B and C illustrates an exploded view of the connector, a lock and unlock position respectively of a second embodiment of the connector;

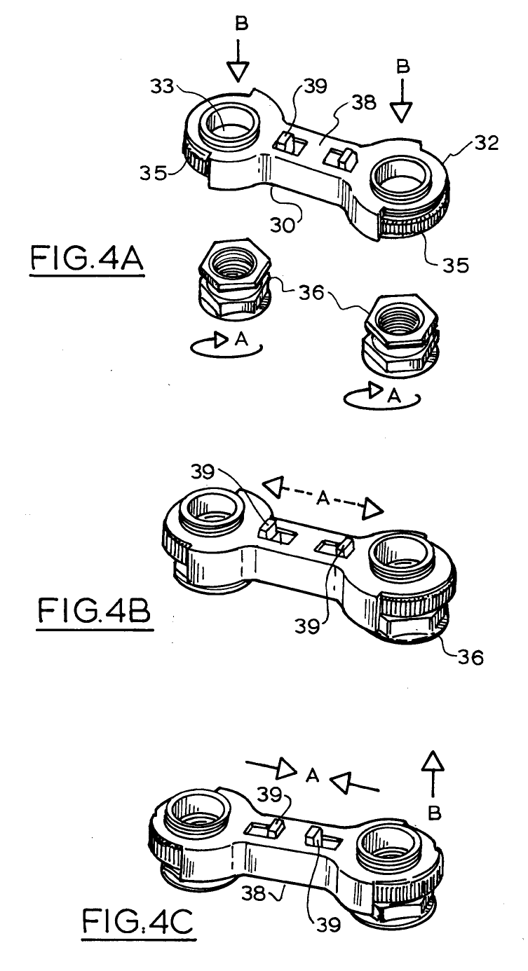

FIGS. 4A B and C illustrates an exploded view of the connector, a lock and unlock position respectively of a third embodiment of the connector;

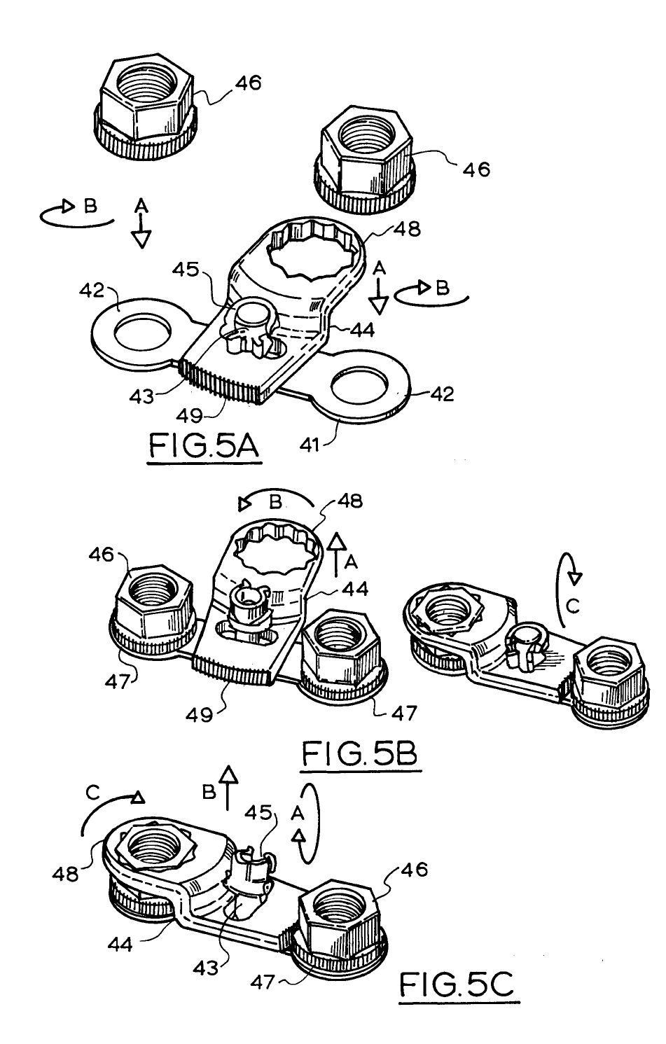

FIGS. 5A B and C illustrates an exploded view of the connector, a lock and unlock position respectively of a fourth embodiment of the connector;

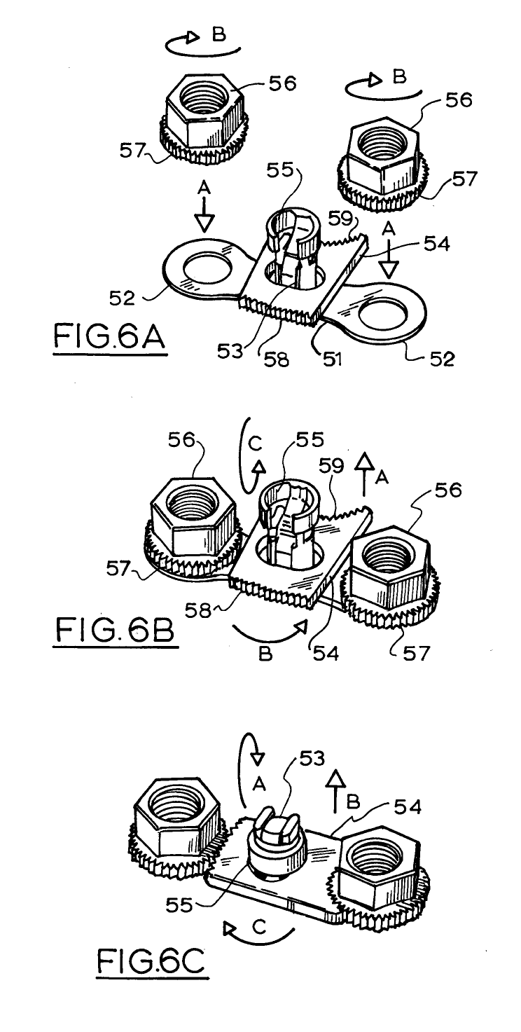

FIGS. 6A B and C illustrates an exploded view of the connector, a lock and unlock position respectively of a fifth embodiment of the connector;

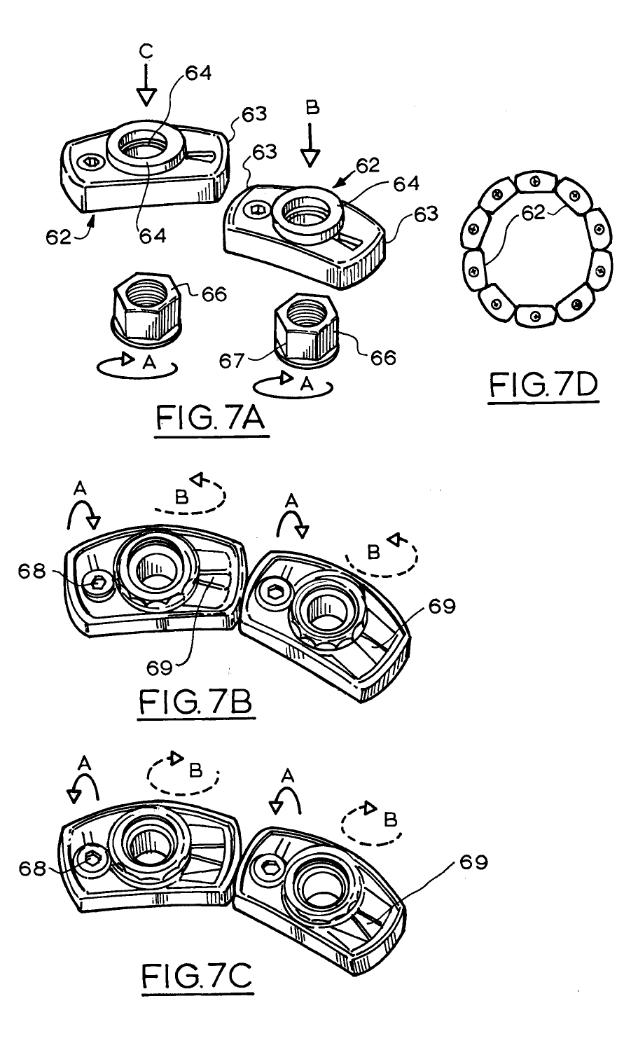

FIGS. 7A B C and D illustrates an exploded view of the connector, a lock, unlock and assemble position respectively of a sixth embodiment of the connector;

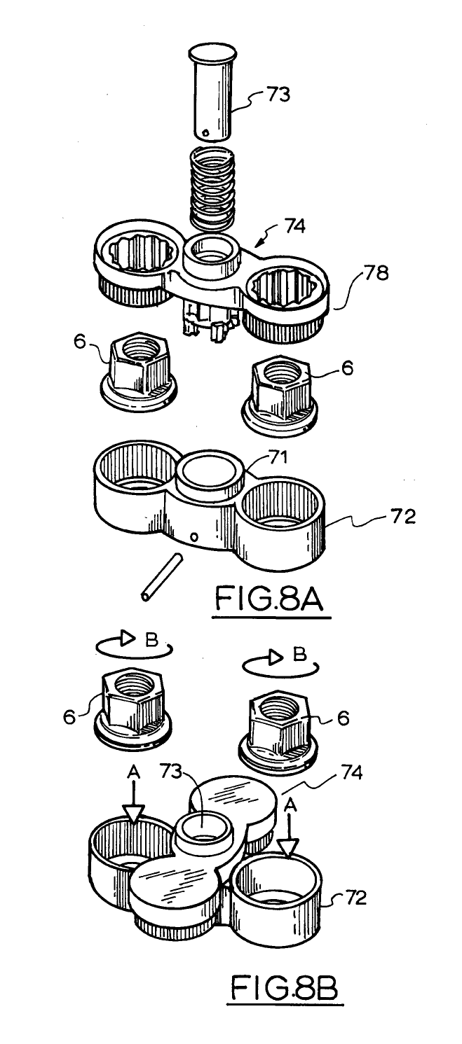

FIG. 8A B is an exploded view and assembly view of a seventh embodiment of the connector;

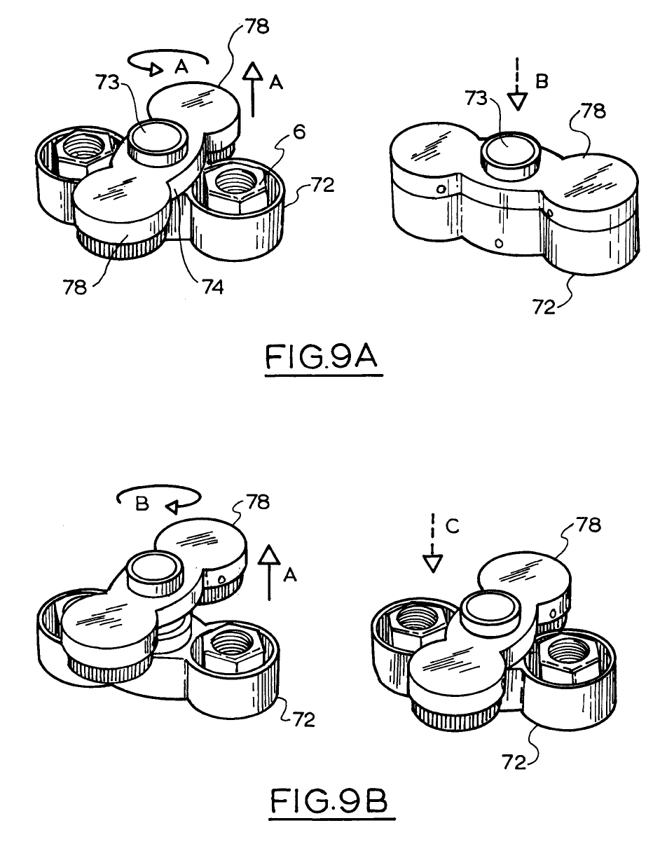

FIG. 9A B illustrates the lock and unlock positions of the connector of FIG. 8;

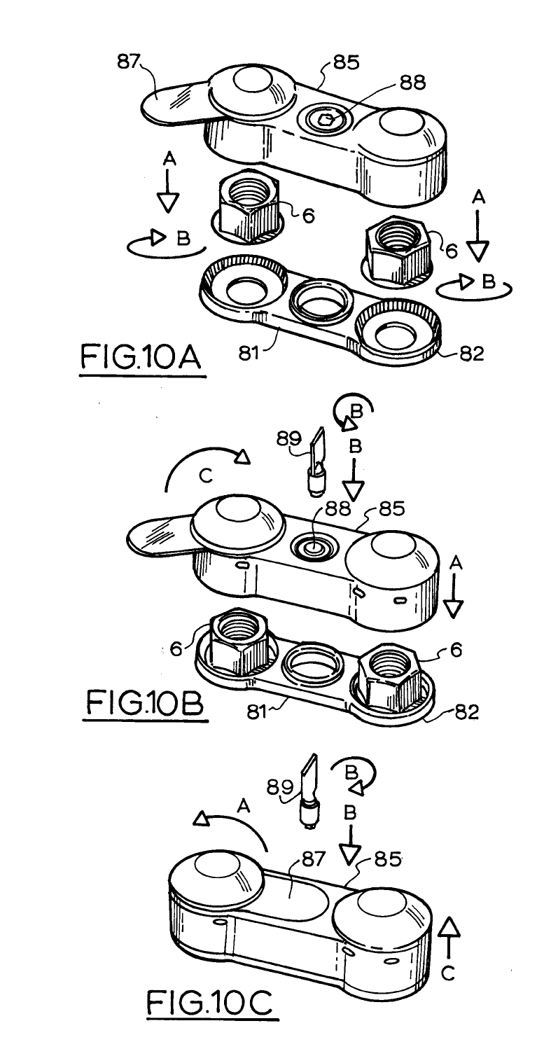

FIGS. 10A B and C illustrates an exploded view of the connector, a lock and unlock position respectively of an eighth embodiment of the connector;

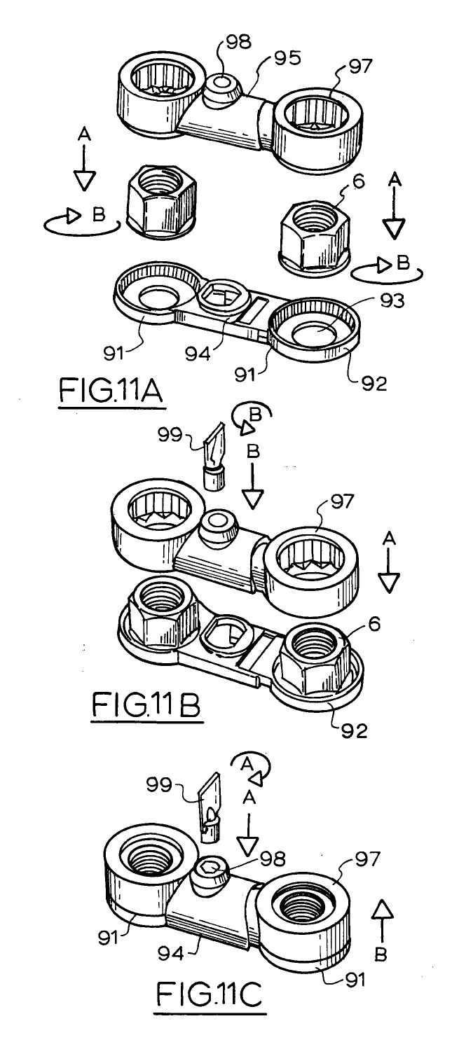

FIGS. 11A B and C illustrates an exploded view of the connector, a lock and unlock position respectively of a ninth embodiment of the connector;

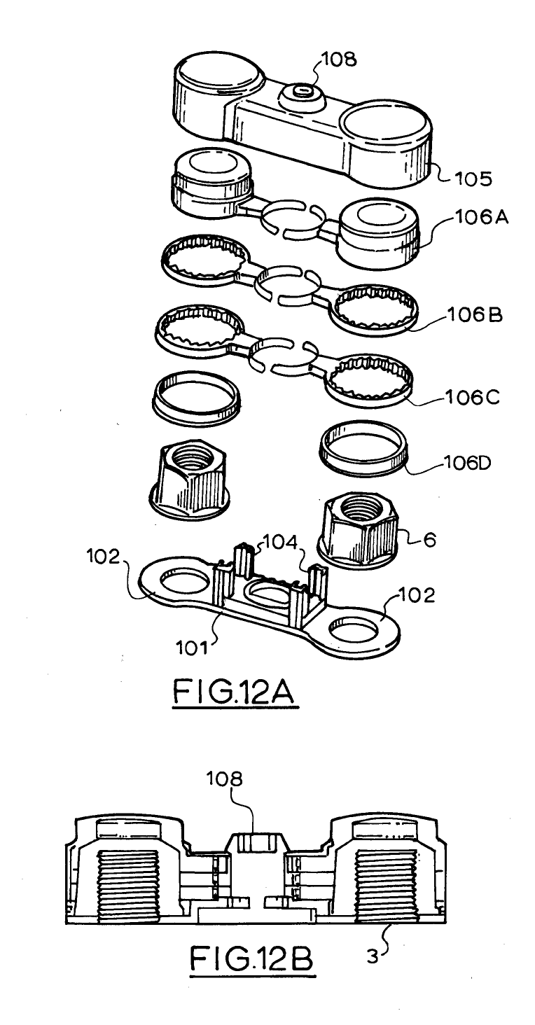

FIG. 12A B C is an exploded view and section view of a tenth embodiment of the connector;

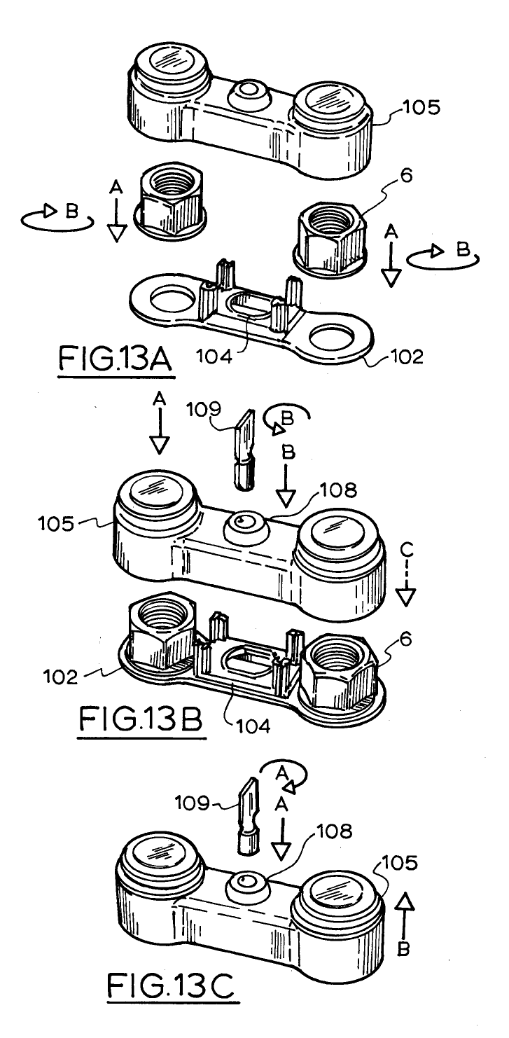

FIG. 13A B illustrates an assemble, lock and unlock views of the connector of FIG. 12;

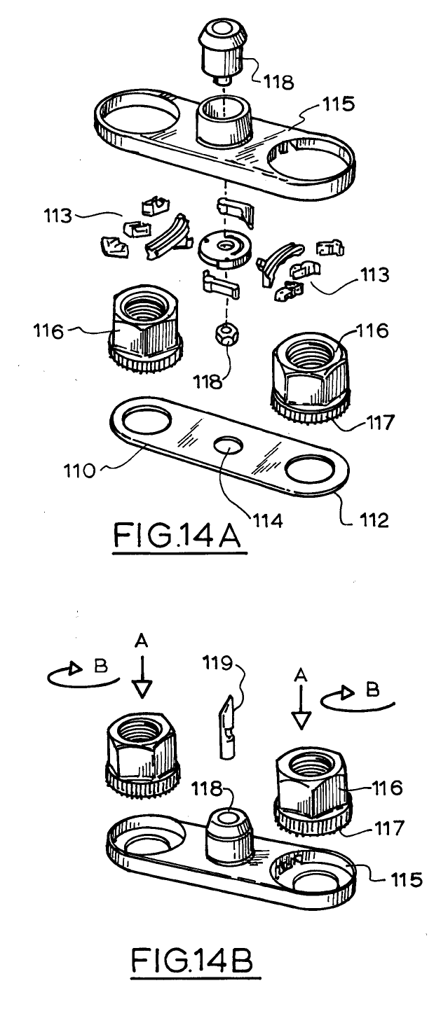

FIG. 14A B is an exploded view and assembly view of a an eleventh embodiment of the connector;

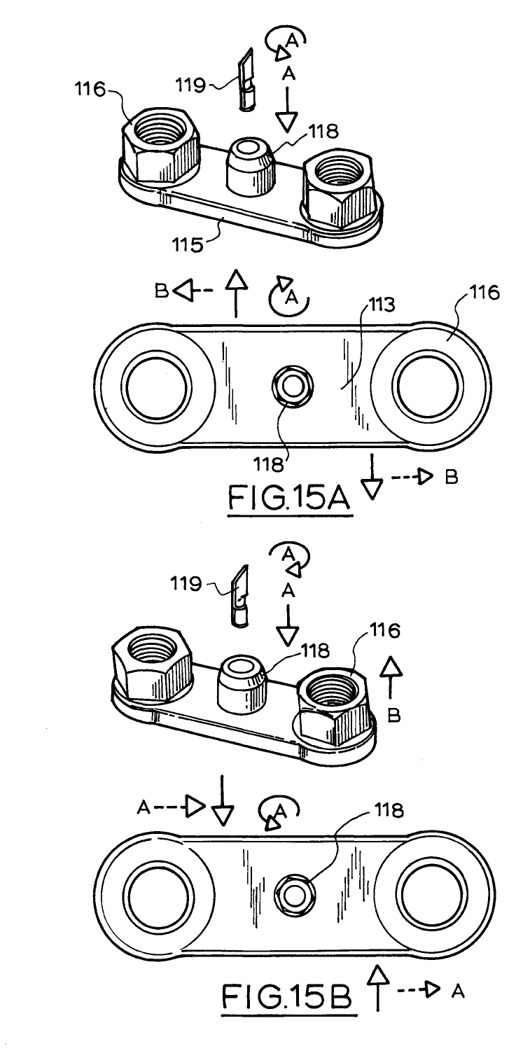

FIG. 15A B illustrates the lock and unlock positions of the connector of FIG. 14;

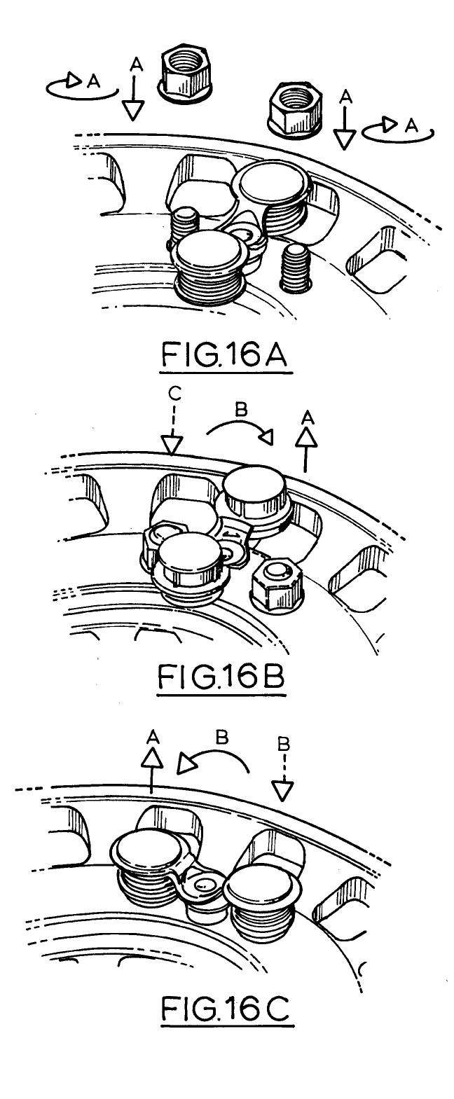

FIG. 16A B C illustrates an assemble, lock and unlock views of the connector of a twelfth embodiment of the connector;

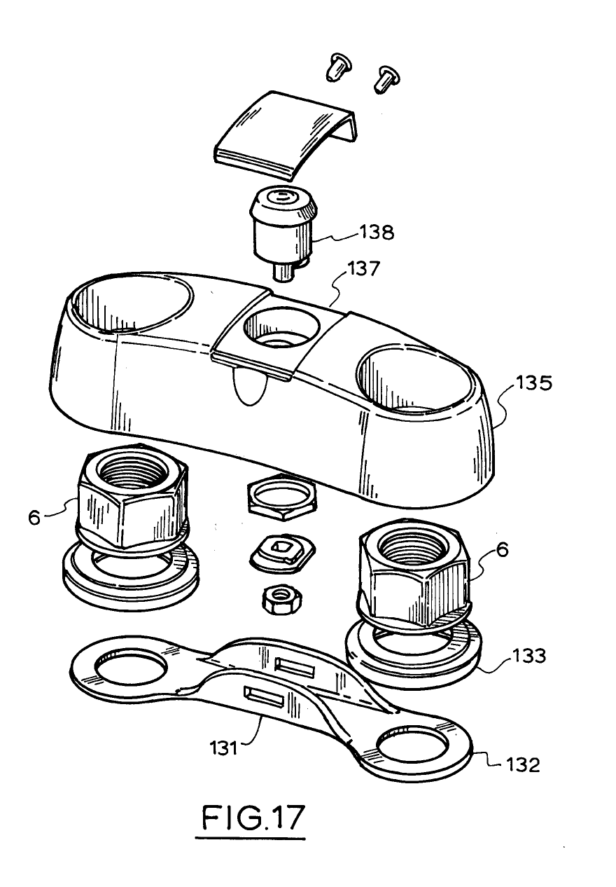

FIG. 17 is an exploded view of a twelfth embodiment of the invention;

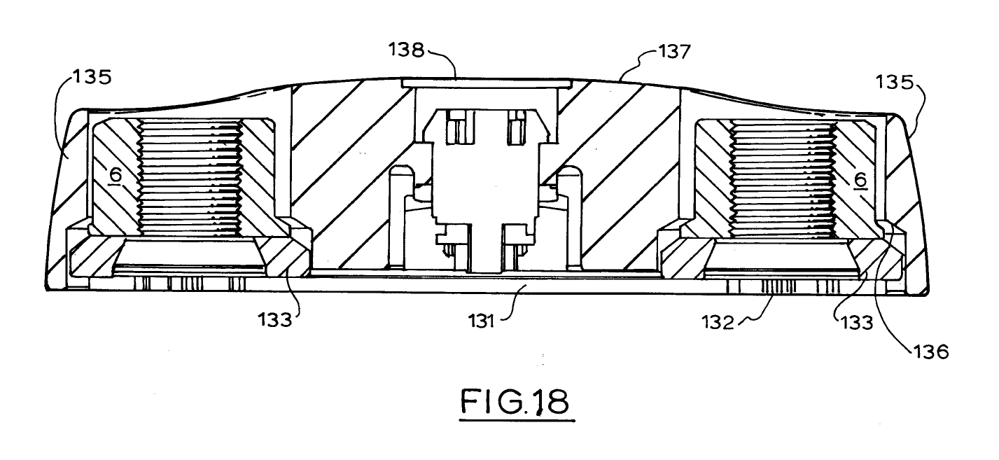

FIG. 18 is a cross sectional view of the assembled system of the twelfth embodiment of FIG. 17.

In all embodiments the wheel hub is secured to the alloy wheel rim 2 by the stud 3 and its associated wheel nut 6. The stud 3 has helical threads that cooperate with corresponding threads on the internal surface of nut 6. The connector 10 links one wheel nut 6 to another preventing both nuts from loosening over time and potentially falling off when the truck is in transit.

In the first embodiment of the invention shown in FIG. 2 the connector 10 consists of a base plate 11 with a pair of cups 12 having holes 13 to fit over the wheel studs 3. The nuts 6 are fastened to the studs 3 and the locking caps 15 are placed over the nuts. The lower rim 16 of the cap 15 incorporates gear teeth to engage corresponding grooves 14 in the base of each cup 12. The upper rim 17 of each cap 15 is serrated to engage the corners of the hexagonal nut 6 so that the caps prevent rotation of the nuts 6. The central portion of the connector 10 between cups 12 is a spring loaded locking mechanism 18, to prevent removal of the caps 15. As shown in FIG. 2C a key 19 is used to unlock the mechanism 18 and allow removal of the caps 15.

In the second embodiment of FIG. 3 the connector 10 is essentially in two parts. One part consists of a gear ring 21 which seats over one nut 6 and the other is a locking part 22 with teeth 23 at one end and a ring 24 with serrated edges 25 to engage the corners of the adjacent hexagonal nut 6 to prevent rotation of the nut 6. The nuts 6 are locked by placing the locking part 22 over the fastened nuts and allowing the spring loaded mechanism 28 to lock onto the nut 6. The nuts may be customised to interact with the lock 28. As shown in FIG. 3C a key 19 is used to unlock the mechanism 28 and allow removal of the caps locking part 22.

In the third embodiment of FIG. 4 the connector 30 consists of a central portion with a pair of annular covers 32 having holes 33 to fit over the wheel studs 3. The custom nuts 36 are fastened to the studs 3 and the covers 32 of connector 30 are placed over the nuts 36. The outer rim 35 of the covers 32 incorporates gear teeth to be engaged by the spring loaded locking mechanism 38. The internal surface of each cover 32 is serrated to engage the corners of the hexagonal nut 36 to prevent rotation of the nuts 36. The central portion of the connector 30 between covers 32 is a spring loaded locking mechanism 38. As shown in FIG. 4C compression of the spring loaded tabs 39 unlocks the mechanism 38 and allow removal of the connector 30.

Another mechanism is illustrated in a fourth embodiment shown in FIG. 5. The connector 40 consists of a base plate 41 with a pair of annular rings 42 to fit over the wheel studs 3. The custom nuts 46 have gear teeth 47 on their lower edges. Locking part 44 is clipped onto the boss 43 in the centre of base plate 41. Boss 43 incorporate a retaining clip 45 which can be turned to lock the part 44 to base plate 41. The locking part 44 includes a ring 48 with an internal serrated edge to engage the corners of the hexagonal nut 46 to prevent rotation of the nuts 46. The other end 49 of part 44 has teeth to engage the gear teeth 47 of the adjacent nut 46. When the locking part 44 engages both nuts 46 the retaining clip 45 is turned to lock the part 44 to base plate 41.

Another mechanism is illustrated in a fifth embodiment shown in FIG. 6. The connector 50 consists of a base plate 51 with a pair of annular rings 52 to fit over the wheel studs 3. The custom nuts 56 have gear teeth 57 on their lower external edges. Locking part 54 is clipped onto the boss 53 in the centre of base plate 51. Boss 53 incorporates a retaining clip 55 which can be turned to lock the part 54 to base plate 51. The locking part 54 includes convex edge 58 with gear teeth and a concave edge 59 to engage the gear teeth 57 of the custom nuts 56. When the locking part 54 engages both nuts 56 the retaining clip 55 is turned to lock the part 54 to base plate 51. To unlock the clip 55 is raised the locking part 54 is lifted clear and the nuts 56 can be removed.

Figure seven illustrates a sixth embodiment in which the connector is in a minimum of two parts and each part is identical and associated with one custom nut. In this embodiment the connectors may link all the nuts as shown in FIG. 7D. Each connector part 62 has concave edges 63 bearing gear teeth that engage with the corresponding edges 63 of adjacent connectors. The central aperture 64 of part 62 is internally shaped to locate on the corners of the custom nut 66 which includes a recess 67 on each corner. An alien key turnable nut 68, engages the recesses 67 in the custom nut 66 to prevent removal of the part 62. The locking of the part 62 exposes a lock status indicator 69 which is green when locked and red when the part 62 is able to be removed.

FIGS. 8 and 9 illustrate a seventh embodiment of the invention in which the connector 70 has a location part 71 with a pair of annular cylinders 72, to fit over the wheel studs 3. The annular cylinders 72 have vertical arrayed splines on its internal surface. Conventional nuts 6 may be used. Locking part 74 is secured by the spring tensioned pivot axis 73 in the centre of location part 71. The locking part 74 includes a pair of caps 78 with an internal grooved surface to engage the splines of cylinders 72 and cover the nuts 6. The locating part 71 is placed over two adjacent nuts and the locking part 74 is rotated so that the caps 78 are over the nuts 6. The spring mechanism closes the part 74 onto part 71. To unlock the part 74 is raised and rotated 90 degrees as shown in FIG. 9B.

In the eighth embodiment of the invention shown in FIG. 10 the connector 80 consists of a base plate 81 with a pair of cups 82 having holes 83 to fit over the wheel studs 3. The nuts 6 are fastened to the studs 3 and the locking part 85 is placed over the nuts. The central portion of the locking part 85 includes a spring loaded locking mechanism 88 to prevent removal of the locking part 85. As shown in FIG. 10C a key 89 is used to unlock the mechanism 88 and allow removal of the locking part 85. The tongue 87 is rotated to cover the lock and prevent ingress of dirt. To remove the locking part 85 the tongue is rotated to expose the lock 88 which is unlocked with the key 89 so that locking part 85 can be removed to allow the nuts 6 to be removed.

In the ninth embodiment of the invention shown in FIG. 11, the connector 90 consists of a base plate 91 in two parts each having cups 92 with holes 93 to fit over the wheel studs 3. The two parts of plate 91 are connectable at location part 94 to accommodate for varying distances between the studs on the wheel rim. The nuts 6 are fastened to the studs 3 and the locking part 95 is placed over the nuts. The central portion of the locking part 95, includes a spring loaded locking mechanism 98 to prevent removal of the locking part 95 from the base plate 91. The locking part 95 includes a ring 97 with an internal serrated edge to engage the corners of the hexagonal nut 6 to prevent rotation of the nuts 6. As shown in FIG. 11C a key 99 is used to unlock the mechanism 98 and allow removal of the locking part 95. The feature of this embodiment is the adjustability of the length of parts 91 and 95.

In the tenth the embodiment of the invention shown in FIGS. 12 and 13 the connector 100 consists of a base plate 101 having 2 annular rings 102 to fit over the wheel studs 3. The central portion 104 of plate 101 is adapted to receive the locking mechanism. The nuts 6 are fastened to the studs 3 and the locking part 105 and the associated rings 106A B and C and D are placed over the nuts. The rings 106A B and C include leaf springs 107 to cooperate with the lock actuator 108 to form a spring loaded locking mechanism. The rings 106A B and C are provided with an internal serrated edge to engage the corners of the hexagonal nut 6 to prevent rotation of the nuts 6. The three rings 106 self align about the nut 6 and variations are compensated for by the leaf springs 107. As shown in FIGS. 13B and C a key 109 is used to unlock the mechanism 108 and allow removal of the locking part 105.

In the eleventh the embodiment of the invention shown in FIGS. 14 and 15 the connector 110 consists of a base plate 111 having 2 annular rings 112 to fit over the wheel studs 3. The central portion 114 of plate 111 is adapted to receive the locking actuator 118. The custom nuts 116 incorporate ratchet teeth 117 on their lower edges. The locking part 115 includes a locking actuator 118 and associated pawls 113 that engage the ratchet teeth 117, to form a locking mechanism. The custom nuts 116 are fastened to the studs 3 after the locking part 115 has been placed on the base plate 111. As shown in FIGS. 15A and B a key 119 is used to turn the actuator 118, disengage the pawls from the ratchet teeth and allow removal of the locking part 115.

FIG. 16 illustrates a twelfth embodiment of the invention in which the connector 120 is attached via its central portion 121 to a stud 124 on the custom wheel rim 2. The connector 120 has a pair of annular cylindrical caps 122 to fit over the wheel nuts 6. The annular cylinders 122 have vertical arrayed splines on its internal surface. Conventional nuts 6 may be used. The nuts 6 are fastened to the studs 3 while the connector is aligned at right angles to the axis between the studs 3. The connector is lifted and turned so that the caps 122 are over the nuts 6. The spring loaded mechanism in the central portion 121 closes the connector 120 onto the wheel nuts. To access the wheel nuts 6 the connector 120 is raised and rotated 90 degrees.

In the twelfth embodiment of the invention shown in FIGS. 17 and 18 the connector 130 consists of a base plate 131 with a pair of holes 132 to fit over the wheel studs 3. The nuts 6 and spacer 133 are fastened to the studs 3 and the locking part 130 is placed over the nuts so that each cylindrical end portion 135 seats over each nut 6. The internal lower rim 136 of the end portions 135 prevents movement of the hexagonal nut 6 along the shaft of the stud 3. The central portion 137 of the connector 130 incorporates a locking mechanism 138 to prevent removal of the connector 130.

Those skilled in the art will realise that this invention provides a unique and less expensive means of ensuring that a wheel nut is securely fastened to the wheel hub. Those skilled in the art will also realise that this invention may be implemented in embodiments other than those described without departing from the core teachings of the invention.

1. A wheel rim with a plurality of studs having external threads to receive fastening nuts;
a wheel nut with an internal thread adapted to be secured to said studs;
a connector adapted to be attached to and connect adjacent nuts;
said connector including a mechanism to prevent rotation of the nuts.

2. A wheel rim as claimed in claim 1 in which the connector is in at least two parts that engage each other.

3. A wheel rim as claimed in claim 1 in which the connector has as many parts as there are studs and these engage each other to form a ring connector connecting all the studs on the wheel rim.

4. A wheel rim as claimed in claim 1 in which the connector is adjustable in length to accommodate a variety of distances between studs.

5. A wheel rim as claimed in claim 1 in which a locking mechanism with a key is used to lock the connector in place.

6. A wheel rim as claimed in claim 1 in which the connector includes a visual indicator that the connector is locked in place.

7. A wheel rim as claimed in claim 1 in which the connector may be secured to a custom wheel rim and is rotatable to align with the nuts and lock them in place.

8. A wheel nut and connector combination for use in the wheel rim as claimed in claim 1 which consists of a wheel nut with an internal thread adapted to be secured to said studs;
a connector adapted to be attached to and connect adjacent nuts;
said connector including a mechanism to prevent rotation of the nuts.

9. A combination as claimed in claim 8 in which the connector is in at least two parts that engage each other.

10. A combination as claimed in claim 9 in which the connector includes a ratchet mechanism.

11. A combination as claimed in claim 8 in which the nut is a custom nut engagable by the connector mechanism

12. A combination as claimed in claim 8 in which the connector has as many parts as there are studs and these engage each other to form a ring connector connecting all the studs on the wheel rim.

13. A combination as claimed in claim 8 in which the connector is adjustable in length to accommodate a variety of distances between studs.
